(19) United States
(12) Patent Application Publication
(10) Pub. No.: US 2016/0150148 A1
(43) Pub. Date: May 26, 2016

(54) WIRELESS NETWORK PHOTOGRAPHING APPARATUS AND SETTING METHOD THEREOF

(71) Applicant: Aether Services, Taiwan, Ltd., Hsinchu City (TW)

(72) Inventors: Chen-Chia TSAI, Zhubei City (TW); Jui-Pin WU, Hsinchu City (TW); Wen-Wei CHANG, Hsinchu City (TW); Hung-Hsin CHENG, Hsinchu City (TW)

(21) Appl. No.: 14/701,207

(22) Filed: Apr. 30, 2015

(30) Foreign Application Priority Data
Nov. 24, 2014 (CN) 201410678191.7

(51) Int. Cl. H04N 5/232

(52) U.S. Cl. CPC H04N 5/23206

(57) ABSTRACT

A wireless network photographing apparatus and a setting method thereof are provided, where the wireless network photographing apparatus includes a switching unit, a network unit, and a processing unit. The processing unit enables a server mode or a client mode according to switching setting of the switching unit. When enabling the server mode, the processing unit enables, by using the network unit, an electronic apparatus to connect to the processing unit and set an apparatus connection parameter. When enabling the client mode, the processing unit performs a network connection according to the apparatus connection parameter and by using the network unit.

### CROSS-REFERENCE TO RELATED APPLICATION

This application claims the benefit of China Patent Application No. 201410678191.7, filed on Nov. 24, 2014, which is hereby incorporated by reference for all purposes as if fully set forth herein.

### BACKGROUND

1. Technical Field

The present invention relates to a wireless data transmission technology, and more particularly to a wireless network photographing apparatus and a setting method thereof, where the wireless network photographing apparatus can be directly set to be connected to a network.

2. Related Art

In the prior art, the wireless network photographing apparatus can be roughly divided into two types. In one practice, first, a wireless network photographing apparatus is connected to a wired network, or in a manner similar to Console connecting, a control apparatus then finds out the wireless network photographing apparatus seeking a connection by utilizing tool software and sets the same by utilizing an interface of the tool software. In another manner, a Bluetooth technology needs to be utilized, so as to connect a control apparatus and a wireless network photographing apparatus in which a Bluetooth module is built, and then the control apparatus sets relevant parameters by utilizing a setting interface of the wireless network photographing apparatus or an interface of tool software.

However, the former manner of the foregoing two manners needs to be limited to a wired connection and requires cooperation of relevant connection lines or tools. In the latter manner, each of the wireless network photographing apparatus and the control apparatus needs to have a Bluetooth module. However, a common wireless network photographing apparatus usually does not have any Bluetooth module. Therefore, adaptability of the two manners is not very high, and operational limitation of the two manners is not small either.

### SUMMARY

In view of this, a main objective of the present invention is to provide a wireless network photographing apparatus and a setting method thereof, so as to complete setting of the wireless network photographing apparatus by means of a wireless connection.

To achieve the foregoing objective, technical solutions of the present invention are implemented as follows: A wireless network photographing apparatus comprises: a switching unit, a network unit, and a processing unit, where the processing unit is connected to the switching unit and the network unit, and enables a server mode (for example, AP mode for WLAN device) or a client mode (for example, station mode for WLAN device) according to setting of the switching unit. When enabling the client mode, the processing unit performs a network connection according to an apparatus connection parameter and by using the network unit. When enabling the server mode, the processing unit enables, by using the network unit, an electronic apparatus to connect to the processing unit and set the apparatus connection parameter.

In a setting method of a wireless network photographing apparatus disclosed by the present invention, a processing unit judges setting of a switching unit, so as to enable a client mode or a server mode; when enabling the server mode, the processing unit enables, by using the network unit, an electronic apparatus to connect to the processing unit and set an apparatus connection parameter; and when enabling the client mode, the processing unit performs a network connection according to the apparatus connection parameter and by using the network unit.

The wireless network photographing apparatus and the setting method thereof provided by the present invention have the following advantages.

The wireless network photographing apparatus can set a parameter in a wireless manner without being limited to a wired connection manner of connection lines or tools or limited to a Bluetooth connection manner, which adapts to a common wireless network photographing apparatus, thereby having relatively high adaptability and applicability.

### BRIEF DESCRIPTION OF THE DRAWINGS

The disclosure will become more fully understood from the detailed description given herein below for illustration only, and thus are not limitative of the disclosure, and wherein:

FIG. 1 is a schematic flowchart of setting of a wireless network photographing apparatus according to an embodiment of the present invention;

FIG. 2 is a schematic apparatus block diagram of a wireless network photographing apparatus according to an embodiment of the present invention; and

FIG. 3A and FIG. 3B are schematic diagrams of entity setting of a wireless network photographing apparatus according to embodiments of the present invention.

### DETAILED DESCRIPTION

A wireless network photographing apparatus and a setting method thereof of the present invention are further described in detail below with reference to the accompanying drawings and embodiments of the present invention. However, the description is merely preferred embodiments of the present invention. This technique of present invention is also applied to the same or similar wireless network apparatus.

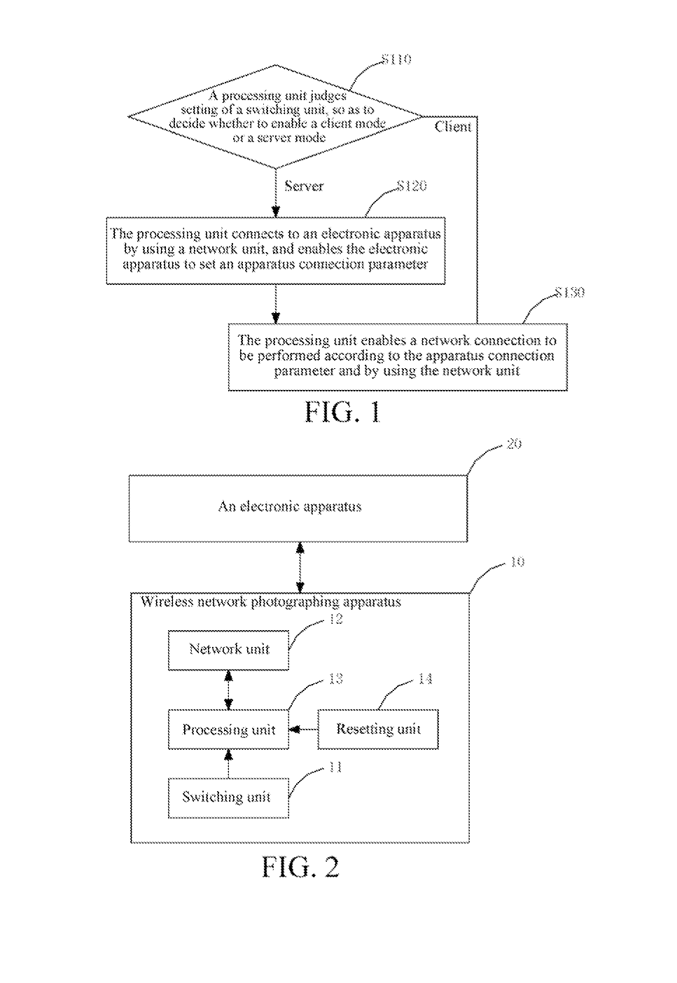

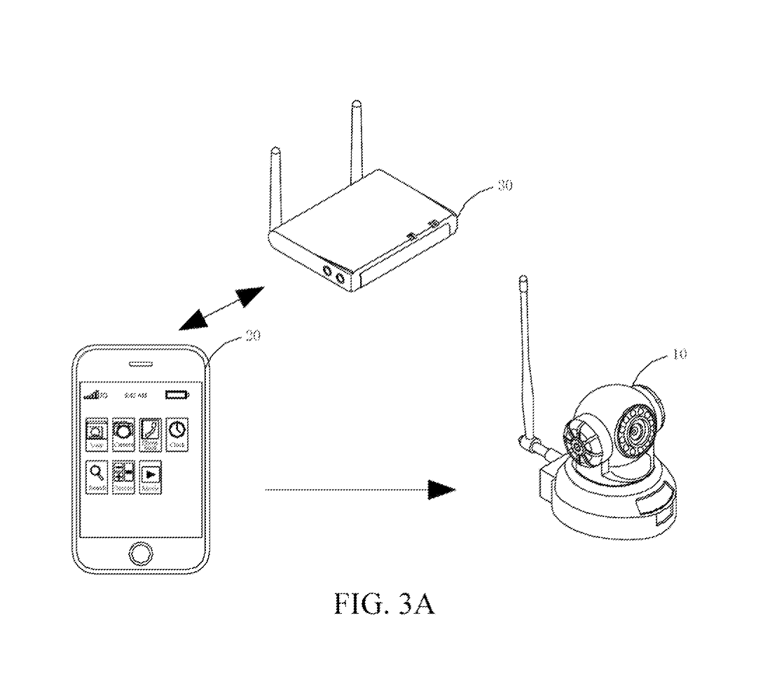

Please refer to FIG. 1, which is a schematic flowchart of setting of a wireless network photographing apparatus 10 according to an embodiment of the present invention, and FIG. 2, which is a schematic apparatus block diagram of a wireless network photographing apparatus 10 according to an embodiment of the present invention together.

The wireless network photographing apparatus 10 includes a switching unit 11, a network unit 12, and a processing unit 13, where the processing unit 13 is connected to the switching unit 11 and the network unit 12, and the processing unit 13 may be software, hardware, or a combination of software and hardware.

The switching unit 11 is a software switch, where a user can present a man-machine interface (software control interface) of the wireless network photographing apparatus 10 on an electronic apparatus 20 when the electronic apparatus 20 remotely connects to the wireless network photographing apparatus 10, so as to operate or trigger the software switch by changing parameter setting or controlling the man-machine interface. For example, after a connection parameter of a third party network apparatus 30 is set in the wireless network photographing apparatus 10, the processing unit 13 triggers the switching unit 11, so as to switch the wireless network photographing apparatus 10 from a server mode to a client mode.

Besides, in some embodiments, the switching unit 11 may also be at least one of an entity switch, an environment aware switch, and a wireless signal receiving module. The entity switch may be a single-pole switch, a pushbutton switch, or other similar entity switch types.

The environment aware switch may be an environment aware component such as a sound sensor, a light sensor, a sound controller, or a light controller. The wireless signal receiving module may be an infrared switch, a radio wave sensitive switch, or a wireless switching component of a relevant or similar type.

The network unit 12 is used for connecting a network to the electronic apparatus 20 having a communication capability, such as a computer having a wireless network function, a smartphone, or a network apparatus such as a wireless access point (AP), a modem, or a router. A manner for setting the wireless network photographing apparatus 10 is described below.

A processing unit 13 judges setting of a switching unit 11, so as to enable a client mode or a server mode (step S110). As described in this step, the processing unit 13 has two operation manners, where one is the client mode and an other is the server mode. When the wireless network photographing apparatus 10 is started, the processing unit 13 decides to enable a specific type of mode according to setting/switching of the switching unit 11, or during an operation of the wireless network photographing apparatus 10, the processing unit 13 sets a mode to be enabled when judging that switching is performed by the switching unit 11.

When the processing unit 13 enables the server mode, by using a network unit 12, the processing unit 13 is used for the electronic apparatus 20 to connect and the processing unit 13 enables the electronic apparatus 20 to set an apparatus connection parameter (step S 120). In this step, the processing unit 13 cooperates with the network unit 12 to enable a network server function.

In this case, the wireless network photographing apparatus 10 is equivalent to a wireless access point (wireless AP) for other wireless network apparatuses or the electronic apparatus 20 having a wireless network capability to connect. A smartphone is used as an example of the electronic apparatus 20 herein. The electronic apparatus 20 sets and adjusts an apparatus connection parameter by building a data processing interface therein, or by using a data processing interface stored therein when the electronic apparatus 20 is connected to the wireless network photographing apparatus 10, wherein the apparatus connection parameter is used for a connection to a third party network apparatus 30 or a connection to the electronic apparatus 20.

When the processing unit 13 enables the client mode, the processing unit 13 enables a network connection to be performed according to the apparatus connection parameter and by using the network unit 12 (step S130). In this step, the wireless network photographing apparatus 10 returns to a general operation mode, and performs a connection by using a set value of the apparatus connection parameter. However, there are at least two connection modes, one of which is a connection to a third party network apparatus 30, and an other of which is a direct connection to the electronic apparatus 20.

However, as described earlier, after the parameter setting changes, the processing unit 13 triggers the software switch, so as to be switched to the client mode. Therefore, after completion of step S120, the processing unit 13 triggers the software switch, so as to be switched to the client mode, and further proceeds to execute step S130. However, the processing unit 13 may also return to step S110, to re-judge whether to perform an operation in the client mode or the server mode.

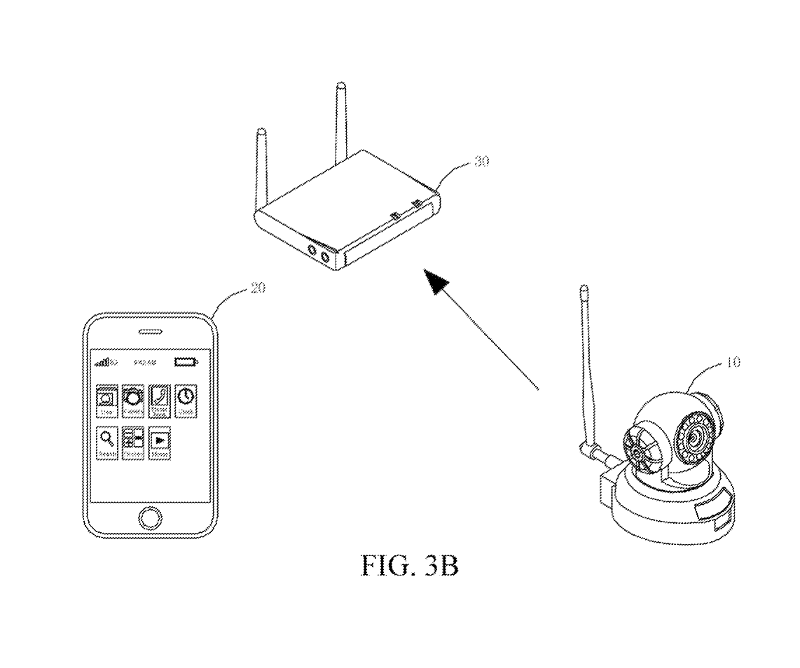

FIG. 3A and FIG. 3B are schematic diagrams of entity setting of a wireless network photographing apparatus 10 according to embodiments of the present invention.

When a user intends to connect the wireless network photographing apparatus 10 to a third party network apparatus 30 (for example, wireless AP), the user may first connect an electronic apparatus 20 to the third party network apparatus 30, so as to obtain network connection setting of the third party network apparatus 30, wherein then electronic apparatus 20 connects to wireless network photographing apparatus 10, which is AP mode now; then, during step S120, the network connection setting is imported or a relevant set value is manually inputted for a processing unit 13 to set an apparatus connection parameter, for example, information such as a service set identifier (SSID), a connection password, and security setting of the third party network apparatus 30. After network connection setting is configured, wireless network photographing apparatus 10 switches to client mode. And next time when wireless network photographing apparatus 10 restarts, switching unit 11 will switch to client mode in step S110.

Oppositely, according to design of a designer, the processing unit 13 may also reversely provide the apparatus connection parameter (before and after setting) for the user to set the connection parameter of the wireless network photographing apparatus 10 in the third party network apparatus 30, so as to facilitate a connection between the two. On an other hand, the electronic apparatus obtains, from the third party network apparatus, a modified set value for update of the connection parameter, and the processing unit 13 obtains the modified set value transmitted by the electronic apparatus 20, so as to update the apparatus connection parameter.

Besides, the user may also first enable a resetting unit 14 of the wireless network photographing apparatus 10 before setting, where the resetting unit 14 is connected to the processing unit 13.

Before judging setting of a switching unit 11, the processing unit 13 resets the apparatus connection parameter or returns to a server mode once the processing unit 13 obtains a resetting signal provided by the resetting unit 14, and the wireless network photographing apparatus 10 returns to default network setting or returns to the server mode. Furthermore, the wireless network photographing apparatus 10 is in a network connection pattern with minimum limitation or without limitation, so that various types of electronic apparatuses 20 having network functions can connect to the wireless network photographing apparatus 10.

As long as the user knows a default parameter of the wireless network photographing apparatus 10, and sets the default parameter in the electronic apparatus 20, the electronic apparatus 20 can connect to the wireless network photographing apparatus 10 and perform parameter setting for the same. Alternatively, in step S120, when enabling the server mode, the processing unit 13 can also first reset the apparatus connection parameter, and then perform a subsequent parameter setting operation.

The above descriptions are merely preferred embodiments of the present invention, but not intended to limit the protection scope of the present invention.

What is claimed is:

1. A wireless network photographing apparatus, comprising:
a switching unit;
a network unit; and
a processing unit, connected to the switching unit and the network unit, wherein the processing unit enables a server mode or a client mode according to setting of the switching unit; when enabling the client mode, the processing unit performs a network connection according to an apparatus connection parameter and by using the network unit; and when enabling the server mode, the processing unit enables, by using the network unit, an electronic apparatus to connect to the processing unit and set the apparatus connection parameter.

2. The wireless network photographing apparatus according to claim 1, wherein the switching unit is a software switch, and when the electronic apparatus remotely connects to the wireless network photographing apparatus, the software switch is triggered according to change of parameter setting, so as to switch the processing unit to the client mode.

3. The wireless network photographing apparatus according to claim 1, further comprising a resetting unit connected to the processing unit, wherein when obtaining a resetting signal provided by the resetting unit, the processing unit resets the apparatus connection parameter, or when enabling the server mode, the processing unit first resets the apparatus connection parameter.

4. The wireless network photographing apparatus according to claim 1, wherein when the processing unit enables the client mode, the processing unit connects to a third party network apparatus by using the network unit.

5. The wireless network photographing apparatus according to claim 4, wherein the electronic apparatus obtains a modified set value from the third party network apparatus to update the apparatus connection parameter.

6. A setting method of a wireless network photographing apparatus, comprising at least the following steps:
judging, by a processing unit, setting of a switching unit, so as to enable a client mode or a server mode;
when enabling the server mode, connecting, by the processing unit, to an electronic apparatus by using a network unit, and enabling the electronic apparatus to set an apparatus connection parameter; and
when enabling the client mode, performing, by the processing unit, a network connection according to the apparatus connection parameter and by using the network unit.

7. The setting method of a wireless network photographing apparatus according to claim 6, wherein when the electronic apparatus sets the apparatus connection parameter, the electronic apparatus first obtains a modified set value from a third party network apparatus, so as to update the apparatus connection parameter.

8. The setting method of a wireless network photographing apparatus according to claim 6, wherein when the processing unit performs the network connection according to the apparatus connection parameter and by using the network unit, the processing unit connects to a third party network apparatus by using the network unit.

9. The setting method of a wireless network photographing apparatus according to claim 6, wherein before judging the setting of the switching unit, the processing unit resets the apparatus connection parameter or switches back to the server mode when judging that a resetting signal is obtained.

10. The setting method of a wireless network photographing apparatus according to claim 6, wherein when enabling the server mode, the processing unit first resets the apparatus connection parameter.
